(19) United States
(12) Patent Application Publication
(10) Pub. No.: US 2007/0296293 A1
(43) Pub. Date: Dec. 27, 2007

(54) Motor assembly having improved flux properties

(76) Inventors: David B. Finkenbinder, Ravenna, OH (US); Michael L. Gilliland, Streetsboro, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/474,822

(22) Filed: Jun. 26, 2006

(51) Int. Cl. H02K 5/00

(52) U.S. Cl. 310/89; 29/596; 310/239

(57) ABSTRACT

A motor assembly having improved flux properties comprises a rotor lamination rotatably disposed within a field lamination. The field lamination comprises a constant cross-sectional dimension, and is configured to provide a pair of opposed, tapered yokes that provide constant impedance to the rotor lamination. The rotor lamination includes a plurality of spaced teeth that are dimensioned so that taper of the yokes changes by a factor of the width of one of the teeth, thereby reducing the material needed to adequately carry the magnetic flux of the rotor lamination.

### TECHNICAL FIELD

The present invention is generally directed to motor assemblies. In particular, the present invention is directed to motor assemblies with an improved lamination design that results in improved electrical performance and improved thermal management capability.

### BACKGROUND ART

Electrical motors are used to operate any number of household appliances—such as mixers, vacuums, compressors and the like—and industrial devices. In their most basic form, electricity is supplied to a motor assembly to rotate a shaft, which in turn operates the equipment directly or through some type of gearing mechanism.

A motor assembly includes an armature from which the shaft axially extends and which is mounted within a field or a brace. Both the armature and field assemblies are separately wound with an insulated wire to facilitate the generation of a magnetic field. Application of an electric current energizes the windings and causes the armature to rotate within the field which in turn rotates the shaft. As is well known, the armature and the field comprise steel laminations that are stacked upon one another to a desired length. This stacking reduces the extraneous eddy currents that would otherwise exist for a solid core armature or a solid core field and also improves the overall motor operating efficiency.

Moreover, efficient operation of the motor is dependent upon many variables of motor design, including, but not limited to, wire resistance, lamination material properties, the size, shape and thickness of the laminations and so on.

In previous motor designs it was believed that a rounded field lamination configuration, was adequate for fractional horsepower motors used for cleaning appliances and the like. However, more efficient motor designs are being researched and produced, as, for example in U.S. Pat. No. 6,762,531, entitled “Motor Assembly Having Improved Flux Properties,” wherein the geometry of a field lamination was tailored to provide an increased air flow area, leading to operational improvements in stack height, conductor length, wire resistance and heat generation. More particularly, the geometry of the field lamination provided substantially equivalent flux density ratios at various positions about the field assembly, resulting in an optimized balance between magnetic flux and cooling airflow. As a result, power and efficiency were improved, while maintaining the cost at or below that of other field assemblies.

Aside from the above-cited reference, it is believed that little if any consideration has been given to improving current motor design by altering the geometry of field laminations. Indeed, for most participants in the motor assembly arts, the current motor design used in fractional horsepower devices has remained relatively unchanged over the past 25 years. Therefore, it is believed that there is a need in the art for a motor assembly having improved flux density properties.

### SUMMARY OF THE INVENTION

In light of the foregoing, it is a first aspect of the present invention to provide a motor assembly having improved flux properties.

It is another aspect of the present invention to provide a motor assembly comprising a field assembly, an armature assembly rotatably received in the field assembly, the field assembly including a plurality of like laminations stacked upon each other, each field lamination comprising a pair of substantially parallel bracket sides, a pair of substantially parallel yoke sides which are substantially perpendicular to the pair of bracket sides, and a yoke having a neck that extends inwardly from each yoke side to form an armature opening therebetween for rotatably receiving the armature assembly, wherein the width of the neck is about twice the width of one of the yoke sides.

### BRIEF DESCRIPTION OF THE DRAWINGS

For a complete understanding of the objects, techniques and structure of the invention, reference should be made to the following detailed description and accompanying drawings, wherein:

FIG. 1 is an elevational view, in partial cross-section of an exemplary motor assembly;

FIG. 2 is a plan view of prior art combination field lamination and rotor lamination for a motor assembly;

FIG. 3 is a plan view of a combination field and rotor lamination for a motor assembly in accordance with this invention;

FIG. 4 shows FIGS. 2 and 3 partially superimposed for comparison;

FIG. 5 shows the combination field and rotor lamination of this invention and shows the geometry that provides a substantially constant impedance across the yoke of the field lamination; and

FIG. 6 is a graph of multiple performance characteristics versus torque, obtained through experimental comparison of the prior art and the present invention.

### BEST MODE FOR CARRYING OUT THE INVENTION

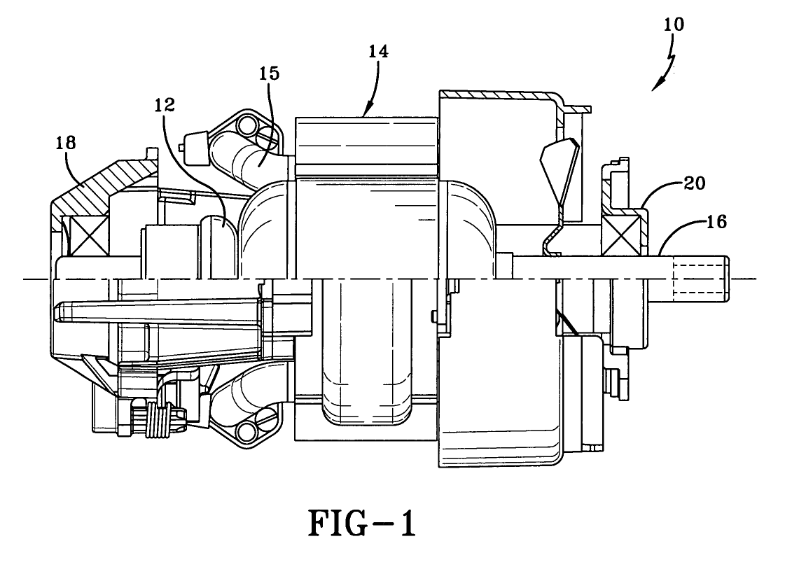

An electric motor assembly according to the present invention is shown in FIG. 1, and is designated generally by the numeral 10. The electric motor assembly 10 includes an armature assembly 12 rotatably received in a field assembly 14. The field assembly 14 includes field windings 15 which are used to generate a magnetic field when energized. Although not readily shown, the armature assembly 12 includes windings to assist in rotation of a shaft 16. One end of the shaft 16 is rotatably supported by a commutator bracket assembly 18 while the other end of the shaft 16 is rotatably supported by an end bracket assembly 20.

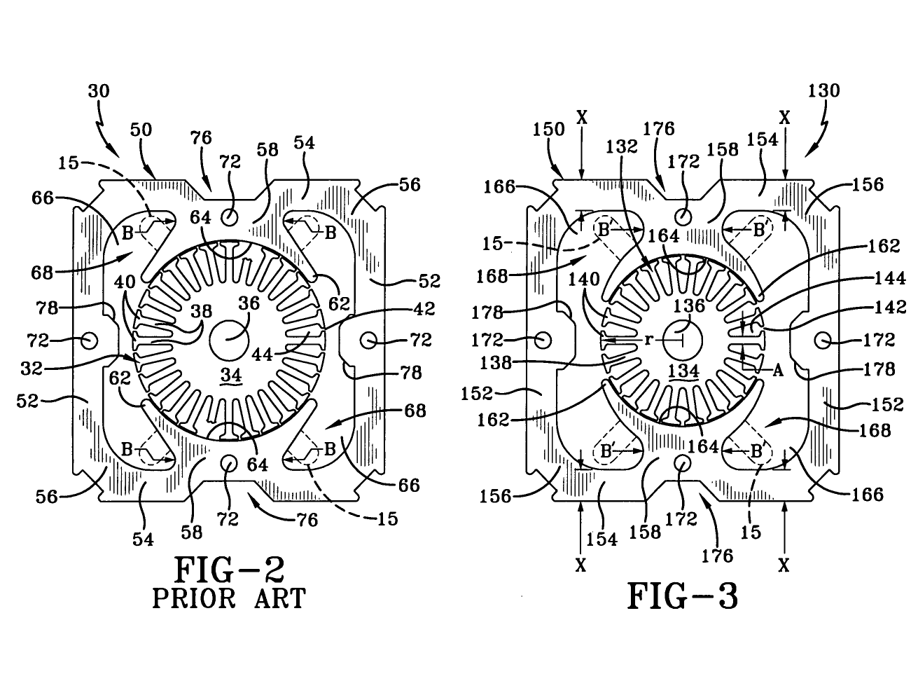

Referring now to FIG. 2, a prior art field lamination is designated generally by the numeral 30, and a corresponding prior art rotor lamination is designated generally by the numeral 32. A plurality of field laminations 30 are stacked one on top of another to form the field assembly 14. In a similar manner, the rotor laminations 32 are stacked one on top of another and then wound with an insulated wire to form the armature assembly 12. The windings are not shown so as to allow for an understanding of the importance of the construction of the rotor and field laminations and their interrelationship. The discussion that follows will set forth the particular structural aspects of the prior art field lamination 30 and rotor lamination 32.

The prior art rotor lamination 32, comprising the armature assembly 12, includes a hub 34, which has extending therethrough a shaft aperture 36 that receives the shaft 16 (shown in FIG. 1). A plurality of teeth 38 radially extend substantially perpendicular from the hub 34. However, in the particular embodiment shown, the rotor lamination 32 includes twenty-eight (28) teeth 38, but more or less teeth could be utilized. A plurality of flanges 40 extend from each end of the teeth 38, such that the flanges 40 collectively form an essentially circular configuration. Adjacent ends of the flanges 40 form a gap 42 which expands into a larger slot 44, which receive the wire windings previously mentioned.

Surrounding the rotor lamination 32 is the prior art field lamination 30 that includes a frame designated generally by the numeral 50. The frame 50 includes a pair of opposed bracket sides 52 which are connected at their respective ends by a pair of yoke sides 54. In particular, the ends of the bracket sides 52 and the yoke sides 54 are interconnected by corners 56. The bracket sides 52 are substantially orthogonal to the yoke sides 54 and vice versa. Extending inwardly from each yoke side 54 is a yoke 58. Extending further inwardly from the yoke 58 are a pair of fingers 62, which form concave sections 64. These concave sections 64 have a radius that effectively embraces or otherwise partially surrounds portions of the armature assembly 12 in such a manner that it is allowed to freely rotate as close as possible to the concave sections 64 without interference. The other sides of the fingers 62 and the interior sides of the yoke sides 54 form troughs 66 which receive the windings 15. Furthermore, those areas not taken up by the windings 15 form airflow areas 68 that allow cooling air to pass therethrough.

In order to assemble the field laminations 30 to one another, a pair of rivet holes 72 may extend through each yoke side 54, such that, when the appropriate number of field laminations 30 are stacked upon one another, a rivet or other suitable fastener may be inserted into the rivet hole 72 for the purpose of coupling the field laminations 30 together.

The yoke sides 54 may provide a notch 76 at about a mid-point thereof. These notches 76 may be used to receive a fastening device which holds the end bracket assembly 20, shown in FIG. 1, of the motor 10 to the commutator bracket assembly 18. The bracket side 52 may include a nub 78 formed on the interior side of the bracket side 52, such that the width of material forming the bracket side 52 is maintained along its length, despite the rivet holes 72. Indeed, the yoke sides 54, the bracket sides 52 and the corners 56 all have substantially the same width. Moreover, the dimensions of the yoke sides 54 and the bracket sides 52 of the field lamination 30 maybe sized so that it can fit within a housing having an opening slightly larger than 3.5 inches square, however, this is not required.

To overcome the limitations in performance of the prior art motor 10, the geometry of the prior art field lamination 30 and rotor lamination 32 has been altered to provide improved magnetic flux movement, and the armature 12 used therewith has been modified to have a reduced diameter. As such, it is these improvements that are the focus of the present invention which will be discussed in detail below.

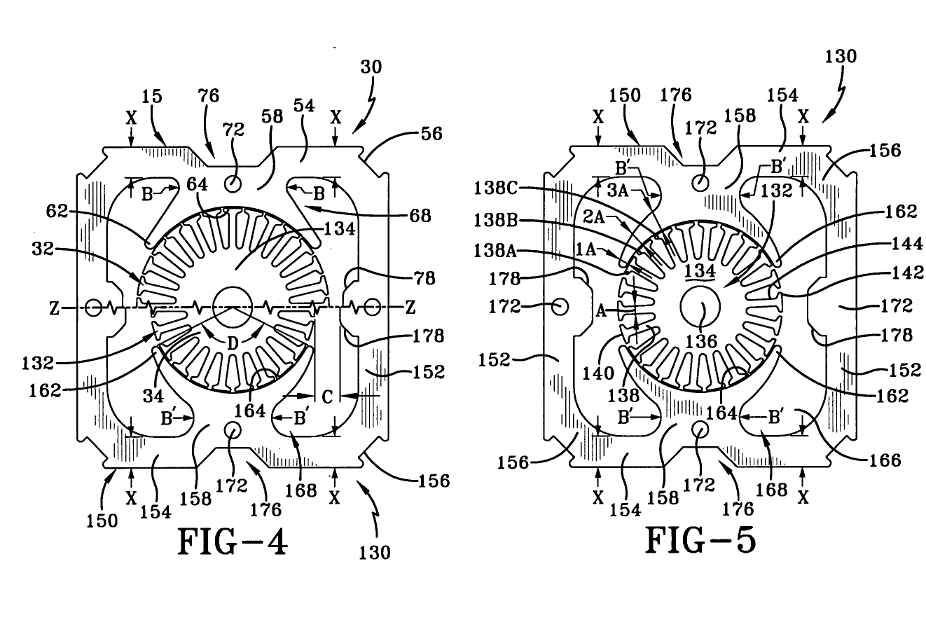

The improved field and rotor lamination is shown in FIG. 3, and is designated generally by the numerals 130 and 132 respectively. Thus, referring to FIGS. 3 and 4, it is seen that the elements of field lamination 130 and rotor lamination 132, as compared to prior art field and rotor laminations 30 and 32, have received like numerals, though increased by 100. The rotor laminations 132, along with field lamination 130 are shown in FIG. 4, superimposed along line Z-Z with the prior art rotor and field laminations 32,30. By superimposing the laminations, the alterations in geometry will be readily evident. By utilizing the field and rotor lamination configuration shown in FIG. 3, it has been found that it is possible to obtain improved operating performance of the motor assembly 10.

The armature 12, shown in FIG. 1, which is comprised of the rotor lamination 132 is configured to have a reduced diameter as compared to that of the prior art rotor lamination 32, and provides several benefits to be discussed below. The rotor lamination 132 includes a hub 134, which has extending therethrough a shaft aperture 136, which receives the shaft 16 of the motor assembly 10. A plurality of teeth 138 radially extend in a substantially perpendicular from the hub 134. In the particular embodiment shown, the rotor lamination 132 includes twenty-two (22) teeth 138, but more or less teeth could be utilized for the operation of the present invention 10. A plurality of flanges 140 extend from each end of the teeth 138, such that the flanges 140 collectively form an essentially circular configuration. Adjacent ends of the flanges 140 form a gap 142 which expands into a larger slot 144, that is configured to receive wire windings.

It should be appreciated that the number of teeth 138 provided in this embodiment is less than that of the prior art rotor laminations 32. This is due to the fact that the diameter of the rotor lamination 132 of the armature 12 of the present embodiment is reduced. By utilizing a prior art rotor lamination 32 with a reduced diameter, the concave section 164 is allowed to embrace a larger number of the teeth 138. This structural feature is beneficial as only the teeth 138 within the embrace of the concave section 164 contribute to power production of the motor 10. The smaller diameter of the rotor laminations 132 also allow for a larger air gap between the rotor laminations 132 and the bracket sides 152, thus reducing flux leakage. In addition, the smaller diameter armature 12 also leaves more area for cooling air to flow through the airflow areas 168 that are provided about the rotor lamination 132 and the field lamination 130. Finally, the smaller diameter of the rotor lamination 132 reduces the armature winding losses 12, allowing the motor 10 to operate more efficiently at higher speed. As will be discussed in further detail, the thickness of a tooth 138 has a dimension designated by the letter A, as shown in FIG. 3. This designation will be used to compare flux density ratios at other locations on the motor assembly 10, and with the improved laminations 130,132 of the present invention.

Field lamination 130 includes a frame designated generally by the numeral 150. The frame 150 includes a pair of opposed bracket sides 152 which are connected at their respective ends by a pair of yoke sides 154. In particular, the ends of the bracket sides 152 and the yoke sides 154 are interconnected by corners 156. The bracket sides 152 are substantially orthogonal to the yoke sides 154 and vice versa. Extending inwardly from each yoke side 154 is a yoke 158. Extending further inwardly from the yoke 158 are a pair of fingers 162 which form concave sections 164. These concave sections have a radius that effectively encloses the armature 12 assembly in such a manner that it is allowed to freely rotate as close as possible to the concave sections 164 without interference. These concave sections 164 effectively increase the polar embrace of the motor assembly. This is accomplished by minimizing the effective diameter of the rotor laminations 132, which allow the sections 164 to embrace more of the teeth 138. The other sides of the fingers 162 and the interior sides of the yoke sides 154 form troughs 166 which receive the windings 15. Those areas not taken up by the windings 15 form airflow areas 168.

As best seen in FIG. 4, the width of the neck B′-B′ that defines the continuation of each yoke side 154 to its respective yoke 158, is smaller in width than the same neck portion B-B of the prior art, shown in FIG. 2. The neck width of the yoke 158 affects the mean turn length, and by providing the neck B′-B′ with a small neck width, allows a smaller mean turn length to be achieved, which in turn yields reduced power (I²R) losses during operation of the motor 10. In accordance with this invention, the width of the neck B′-B′ is made to be approximately twice the width of yoke side 154, which is designated by X-X shown in FIG. 4. More particularly, the width of the neck B′-B′ may be twice as large as the width X-X of the yoke side 154 of the field lamination 130, so as to achieve the optimum balance between magnetic flux and reduced (I²R) losses.

In order to assemble the field laminations 130 to one another, a pair of rivet holes 172 may extend through each yoke side 154. Accordingly, when the appropriate number of laminations 130 are stacked upon one another, a rivet or other suitable fastener may be inserted into the rivet hole 172 for the purpose of holding the laminations in place. The yoke sides 154 may also be provided with a pair of insulator holes (not shown) for receiving an insulation bracket or other retaining device that is used to hold the field laminations 130 to one another.

The exterior portion of the yoke sides 154 may provide a notch 176 at about a mid-point thereof. These notches 176 are used to receive a fastening device which holds the end bracket assembly 20 to the commutator bracket assembly 18 (shown in FIG. 1). It will be appreciated that a nub 178 is formed on an interior side of the bracket side 152, such that the width of the material forming the bracket sides 152 is maintained along its length, despite rivet holes 172. Indeed, the yoke sides 154, the bracket sides 152 and the corners 156 all have substantially the same width. Moreover, the field lamination 130 may be sized so that it can fit within a housing having an opening slightly larger than 3.5 inches square.

It can be seen that yoke 158 does not flare outwardly to the same extent as yoke 58. Thus, as compared to the prior art, the outside diameter (OD) of the rotor lamination 132 is positioned further away from the flux-carrying bracket sides 152 (including nub 178) of its associated field lamination 130. This lessens flux leakage, because the larger gap compels more flux to stay within the path maintained by the field lamination 130 instead of “jumping” across the air gap between the bracket sides 152 and the rotor laminations 132 of the armature 12. Returning to FIG. 3, the radius of rotor lamination 132 is designated by the letter “r,” and the distance between the OD of rotor lamination 132 and the closest portion of bracket side 152, namely nub 178, is designated by the letter C. And in accordance with this invention, the ratio of “r” to C (r:C) preferably ranges from about 2.8 to about 3.5. Ideally, the ratio is about 3.3.

Herein, the geometry of the yoke 158 is selected in part by the angle D shown in FIG. 4, defined by drawing lines from the center of field lamination 130 to the tips of the fingers 162 of the yoke 158. Because the yoke 158 has a lesser flare, angle D of field lamination 130 is larger than in the prior art field lamination 30. Although too much of an increase in angle D can result in counter torque and sparks being generated upon operating the motor assembly 10, angle D is about 130°. It should also be appreciated that the tips of the fingers 162 may extend as far as possible without being wider than the diameter (2r) of the rotor lamination 132. This configuration allows for the maximum use of the windings between the teeth 138. Indeed, the concave section is configured to be in juxtaposition to as many teeth as possible while still allowing at least two of the rotor windings to be unenergized to ensure efficient operation of the motor.

The geometry of the yoke 158 is also selected to maintain a substantially constant impedance across the surface of the yoke 158. To define this geometry, the width A of the teeth 138 of rotor lamination 132 is considered. The yoke 158 preferably widens as it transitions from the tip of each finger 162 to the neck B′-B′. As such, the yoke 158 widens in relation to the positioning of teeth 138 as they embrace the concave section 164. Referring to FIG. 5, it can be seen that a first tooth 138A, positioned just within the embrace of yoke 158 at the end or tip of finger 162, has a width A, which is substantially equal to the width A of each tooth. And the tip of finger 162 is tapered at substantially that thickness or width A. Moving to the second tooth 138B, which is adjacent tooth 138A, it can be seen that tooth 138B also has a width A. And it can be seen that yoke 158, at the position of the second tooth 138B, tooth immediately adjacent the first tooth 138A, has a width of 2A (twice the width A of a single tooth 138). Similarly, at a third tooth 138C, which is the tooth immediately adjacent the second tooth 138B, within the embrace of the yoke 158 has a width of 3A (three times the width A of a single tooth 138). This relation is symmetrically repeated for each portion of each yoke 158 extending from the neck thereof to the fingers thereof. Thus, because space is limited within the field lamination 130, the field lamination 130 is configured so as to provide a sufficient amount of iron to effectively and more efficiently carry the magnetic flux around the field lamination 130 without having a weak structural region, while still providing adequate troughs 166 and air flow areas 168 to provide adequate cooling of the motor 10.

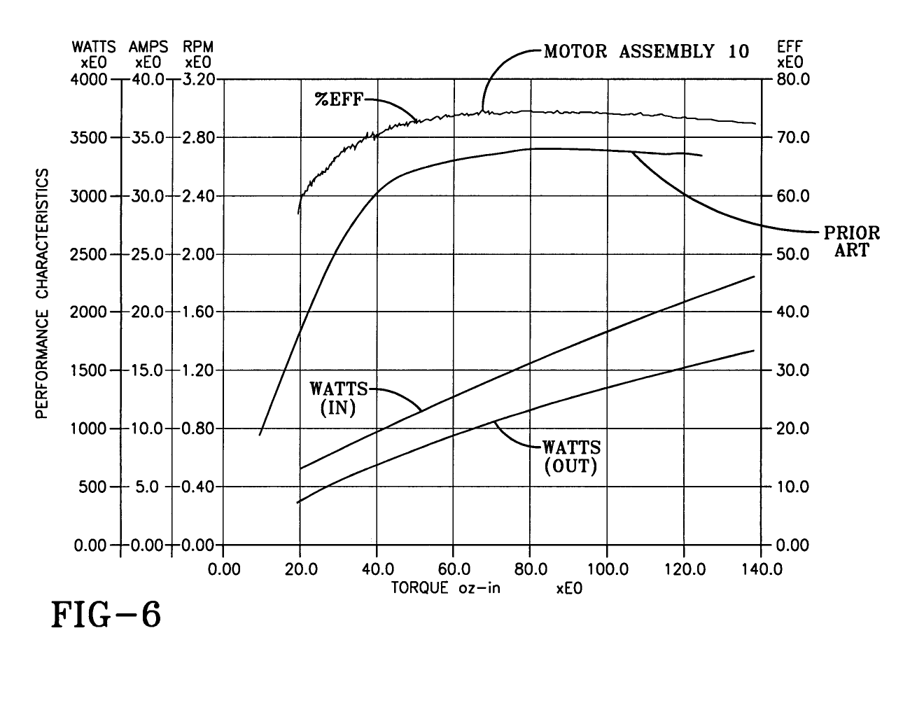

Evidence of the improved efficiency of the motor assembly 10 that employs the field lamination 130 and the rotor lamination 132, as opposed to the laminations 30 and 32 of the prior art, can be seen in the graph shown in FIG. 6. The graph shows various performance characteristics including: the watts consumed, and the efficiency of the motor 10 utilizing the rotor and field laminations 130, 132 as compared to a prior art assembly. As can be seen, there is a significant improvement in the efficiency of the motor assembly 10 over the prior art motor assembly.

Therefore, one advantage of the motor assembly having improved flux properties is that a field lamination using the minimum amount of iron to carry the magnetic flux about the field lamination is utilized, while still providing adequate airflow therethrough. Another advantage of the motor assembly having improved flux properties is that an armature having rotor laminations with a reduced diameter are utilized so as to increase the rotational speed of the motor. Still another advantage of the motor assembly having improved flux properties is that the field lamination provides a uniform or constant cross-section. Yet another advantage of the motor assembly having improved flux properties is that a constant impedance is provided by a yoke of the field assembly.

Thus, it can be seen that the objects of the invention have been satisfied by the structure and presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A motor assembly comprising:
a field assembly;
an armature assembly rotatably received in said field assembly, said field assembly including a plurality of like laminations stacked upon each other, each said field lamination comprising;
a pair of substantially parallel bracket sides;
a pair of substantially parallel yoke sides which are substantially perpendicular to said pair of bracket sides; and
a yoke having a neck that extends inwardly from each said yoke side to form an armature opening therebetween for rotatably receiving said armature assembly, wherein the width of said neck is about twice the width of one of said yoke sides.

2. The motor assembly of claim 1, wherein said armature assembly comprises a plurality of spaced, radially extending teeth.

3. The motor assembly of claim 2, wherein said yoke comprises a pair of tapered fingers, said fingers providing an embrace to a portion of said teeth of said armature assembly.

4. The motor assembly of claim 3, wherein said tapered fingers are configured to carry the magnetic flux of said armature teeth within the embrace of said yoke.

5. The motor assembly of claim 3, wherein each said tooth has a thickness A which corresponds to a thickness of said tapered finger.

6. The motor assembly of claim 5, wherein an end of said tapered finger has a thickness dimension substantially equivalent to said thickness A.

7. The motor assembly of claim 6, wherein said tapered finger has a position adjacent said end of said tapered finger that has a thickness dimension about two times said thickness A and which is in immediate juxtaposition to a second tooth adjacent said tooth that is in juxtaposition to said end of said tapered finger.

8. The motor assembly of claim 7, wherein said tapered finger has another position adjacent said adjacent position that has a thickness dimension about three times said thickness A and which is in immediate juxtaposition to a third tooth adjacent said second tooth.

9. The motor assembly of claim 1, wherein said field assembly has a constant cross section.

10. The motor assembly of claim 1, wherein the width of the neck is about twice that of said yoke sides.

11. The motor assembly of claim 1, wherein the width of the neck is about twice that of said bracket sides.

12. The motor assembly of claim 1, wherein said yoke provides a constant impedance to each of said fingers disposed within the embrace of said yoke.
